(19) United States
(12) Patent Application Publication
(10) Pub. No.: US 2026/0105521 A1
(43) Pub. Date: Apr. 16, 2026

(54) PRESENTATION SYSTEM, PRESENTATION METHOD, PROGRAM

(71) Applicant: Panasonic Intellectual Property Management Co., Ltd., Osaka (JP)

(72) Inventor: Genki JOGAN, Osaka (JP)

(21) Appl. No.: 19/421,489

(22) Filed: Dec. 16, 2025

Related U.S. Application Data
(63) Continuation of application No. PCT/JP2024/020716, filed on Jun. 6, 2024.

(30) Foreign Application Priority Data
Jun. 27, 2023 (JP) 2023-105239

(51) Int. Cl. G06Q 40/04; G06Q 50/06

(52) U.S. Cl. CPC G06Q 40/0431; G06Q 50/06

(57) ABSTRACT

A presentation system includes a first arithmetic circuit accessible to energy information including information regarding a history of prices of a plurality of energy plans, environmental value information including information regarding a history of prices of a plurality of environmental value plans, and demand information including an energy demand and an environmental target. The first arithmetic circuit is configured to present, based on the energy information and the environmental value information, a plurality of combination plans of an energy plan and an environmental value plan which satisfy the energy demand and the environmental target, and an indicator value of a risk of price fluctuation for each of the plurality of combination plans.

### CROSS-REFERENCE TO RELATED APPLICATIONS

The present application is a continuation of PCT/JP2024/020716 filed Jun. 6, 2024, which claims the priority to Japanese Patent Application No. 2023-105239, filed on Jun. 27, 2023, the entire content of which is incorporated herein by reference.

### TECHNICAL FIELD

The present disclosure relates to presentation systems, presentation methods, and programs.

### BACKGROUND ART

Patent Document 1 discloses a power trading intermediary apparatus. The power trading intermediary apparatus includes an environmental value information storage unit, a supplied power information storage unit, an information output unit that outputs information to a prospective purchaser, and an information reception unit that receives demand information from the prospective purchaser, the demand information including environmental value conditions to be satisfied by the non-fossil certificate to be provided and power conditions to be satisfied by the supplied power to be provided. The apparatus further includes an extraction unit for extracting combinations of information on non-fossil certificates and information on supplied power that satisfy the environmental value conditions and the power conditions included in the demand information received from the prospective purchaser, from among the information stored in the environmental value information storage unit and the supplied power information storage unit.

### PRIOR ART DOCUMENTS

### Patent Documents

Patent Document 1: JP 2022-18463 A

### SUMMARY OF THE INVENTION

### Problems to be Solved by the Invention

Patent Document 1 extracts combinations of information relating to non-fossil certificates (environmental value plans) that satisfy the environmental value conditions included in the demand information received from the prospective purchaser and information relating to supplied power (energy plans) that satisfy the power conditions. Generally, the amount of electricity generated by renewable energy fluctuates due to weather and other conditions, and fluctuations in generation volume can also lead to changes in energy supply and price. Therefore, if a prospective purchaser purchases additional electricity beyond their expectations, the additional purchase of environmental value may also be required to satisfy the environmental value conditions, which can result in a substantial financial burden. Accordingly, when selecting energy plans and environmental value plans, there is a need to keep the price within the range desired by the prospective purchaser.

The present disclosure provides a presentation system, a presentation method, and a program which enable more appropriate selection of an energy plan and an environmental value plan.

### Solutions to the Problems

A presentation system according to one aspect of the present disclosure includes an arithmetic circuit accessible to energy information including information regarding a history of prices of a plurality of energy plans, environmental value information including information regarding a history of prices of a plurality of environmental value plans, and demand information including an energy demand and an environmental target. The arithmetic circuit is configured to present, based on the energy information and the environmental value information, a plurality of combination plans of an energy plan and an environmental value plan which satisfy the energy demand and the environmental target, and an indicator value of a risk of price fluctuation for each of the plurality of combination plans.

A presentation method according to one aspect of the present disclosure is performed by an arithmetic circuit accessible to energy information including information regarding a history of prices of a plurality of energy plans, environmental value information including information regarding a history of prices of a plurality of environmental value plans, and demand information including an energy demand and an environmental target, and includes presenting, based on the energy information and the environmental value information, a plurality of combination plans of an energy plan and an environmental value plan which satisfy the energy demand and the environmental target, and an indicator value of a risk of price fluctuation for each of the plurality of combination plans.

A program according to one aspect of the present disclosure is a program for enabling the arithmetic circuit to perform the above presentation method.

### Effects of the Invention

Aspects of the present disclosure enable more appropriate selection of an energy plan and an environmental value plan.

### BRIEF DESCRIPTION OF THE DRAWINGS

FIG. 1 is a schematic diagram of a recommendation system of one embodiment.

FIG. 2 is a block diagram of a presentation system of the recommendation system of the above embodiment.

FIG. 3 is a block diagram of an information terminal of the recommendation system of the above embodiment.

FIG. 4 is a flowchart of part of an operation of the presentation system of the above embodiment.

FIG. 5 is a flowchart of part of an operation of the presentation system of the above embodiment.

FIG. 6 is a flowchart of part of an operation of the presentation system of the above embodiment.

FIG. 7 is a schematic view of part of an input screen by the presentation system of the above embodiment.

FIG. 8 is a schematic view of part of an input screen by the presentation system of the above embodiment.

FIG. 9 is a schematic view of part of an input screen by the presentation system of the above embodiment.

FIG. 10 is a schematic view of part of an output screen by the presentation system of the above embodiment.

FIG. 11 is a schematic view of part of an output screen by the presentation system of the above embodiment.

FIG. 12 is a sequence schematic diagram of a first example of an operation of the recommendation system of the above embodiment.

FIG. 13 is a sequence schematic diagram of a second example of an operation of the recommendation system of the above embodiment.

### DETAILED DESCRIPTION

### 1. Embodiments

Hereinafter, embodiments of the present disclosure will be described with reference to the drawings where appropriate. However, the following embodiments are merely examples for explaining the present disclosure, and are not intended to limit the present disclosure to the following content (e.g., shapes, dimensions, arrangement and the like, of components). Positional relationships such as up, down, left, and right are based on the positional relationships shown in the drawings, unless otherwise specified. Each figure described in the following embodiments is a schematic diagram, and the ratios of size and thickness of each component in each figure do not necessarily reflect the actual dimensional ratios. Furthermore, the dimensional ratios of each element are not limited to the ratios shown in the drawings.

In the following description, if it is necessary to distinguish a plurality of components from each other, prefixes, such as, “first”, “second”, or the like are attached to names of such components. However, if these components can be distinguished from each other by reference signs attached to those components, such prefixes, such as, “first”, “second”, or the like, may be omitted in consideration of readability of texts.

Note that, in the following description, if it is necessary to distinguish a plurality of components from each other, suffixes, such as, “−1”, “−2”, or the like are attached to reference signs of such components. if there is no need to distinguish such components from each other, such suffixes, such as, “−1”, “−2”, or the like, may be omitted in consideration of readability of texts.

### 1.1 Configurations

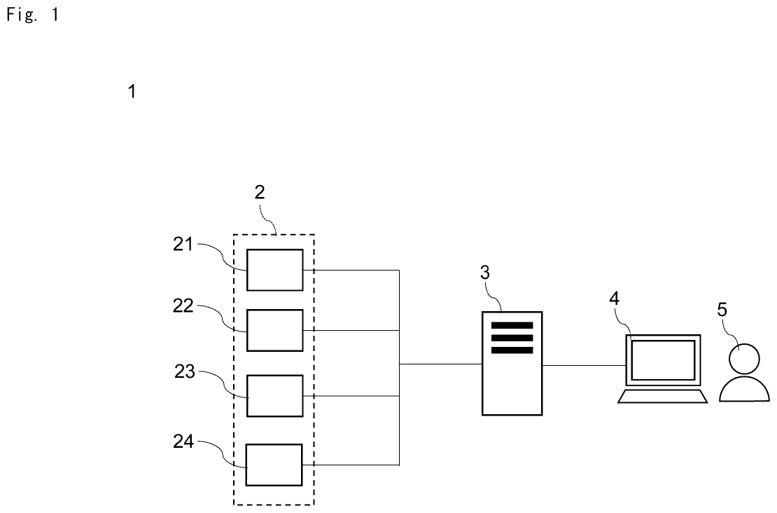

FIG. 1 is a schematic diagram of a recommendation system 1 according to the present embodiment. The recommendation system 1 is used to extract, from a plurality of energy plans and a plurality of environmental value plans, a combination plan of an energy plan and an environmental value plan which matches an environmental target of a user 5, and present it.

An energy plan stipulates an arrangement under which an energy provider supplies energy. An energy plan includes an energy type and an energy price. Examples of the energy type include electricity, liquefied natural gas (LNG), and gasoline. The energy price is, for example, a monetary amount per unit of energy. As an example, when the energy is electricity, the unit of the energy price is yen per kWh. Examples of the energy provider include retail electricity suppliers and the like.

An environmental value plan stipulates an arrangement under which an environmental value provider supplies an environmental value. The environmental value plan includes an environmental value type and an environmental value price. Examples of the environmental value type include J-Credits, Non-Fossil Certificates, and Green Power Certificates. The environmental value price is, for example, a monetary amount per unit of electricity or per unit of CO₂. The unit of the J-Credit is yen per ton of CO₂, and the units of the Non-Fossil Certificate and the Green Power Certificate are yen per kWh. Examples of the environmental value provider include power generation operators and the like.

A combination plan is defined by a combination of an energy plan and an environmental value plan. The combination plan necessarily includes at least one energy plan but does not necessarily include an environmental value plan.

An environmental target is set as an initiative for addressing climate change. For example, environmental targets are set based on international initiatives for the disclosure and evaluation of corporate efforts to address climate change, such as the Science Based Targets (SBT), Renewable Energy 100% (RE100), or Japanese laws, such as the Act on the Rational Use of Energy (Act on the Rational Use of Energy and Conversion to Non-Fossil Energy) and Global Warming Countermeasures Act (Act on Promotion of Global Warming Countermeasures).

The recommendation system 1 includes an information source 2, a presentation system 3, and an information terminal 4.

The information source 2 includes a measurement equipment 21, a power generation equipment 22, an energy provider server 23, and an environmental value provider server 24.

The measurement equipment 21 measures an energy consumption at a facility of the user 5. The energy consumption is an electricity consumption, for example. The measurement equipment 21 includes one or more power meters for measuring a power consumption at the facility of the user 5.

The renewable energy equipment 22 provides renewable energy to the facility of the user 5. The renewable energy equipment 22 may be a facility that generates electricity from non-fossil energy sources, such as a solar power generation facility or a wind power generation facility, for example.

The energy provider server 23 stores information regarding one or more energy plans that can be offered by the energy provider. The energy provider server 23 also stores information regarding a history of prices of energy plans over a predetermined period. The price of an energy plan may be updated, for example, at intervals of predetermined time. Although not particularly limited, the predetermined time is preferably as short as possible, and the predetermined period is preferably as long as possible. For example, the predetermined time may be one hour, and the predetermined period may be one year.

The environmental value provider server 24 stores information regarding one or more environmental value plans that can be offered by the environmental value provider. The environmental value provider server 24 also stores information regarding a history of prices of environmental value plans over a predetermined period. The price of an environmental value plan may be updated, for example, at intervals of predetermined time. Although not particularly limited, the predetermined time is preferably as short as possible, and the predetermined period is preferably as long as possible. For example, the predetermined time may be one hour, and the predetermined period may be one year.

In FIG. 1, only one energy provider server 23 and one environmental value provider server 24 are illustrated for simplicity; however, the number of energy provider servers 23 and the number of environmental value provider servers 24 are not limited to one, and may be two or more.

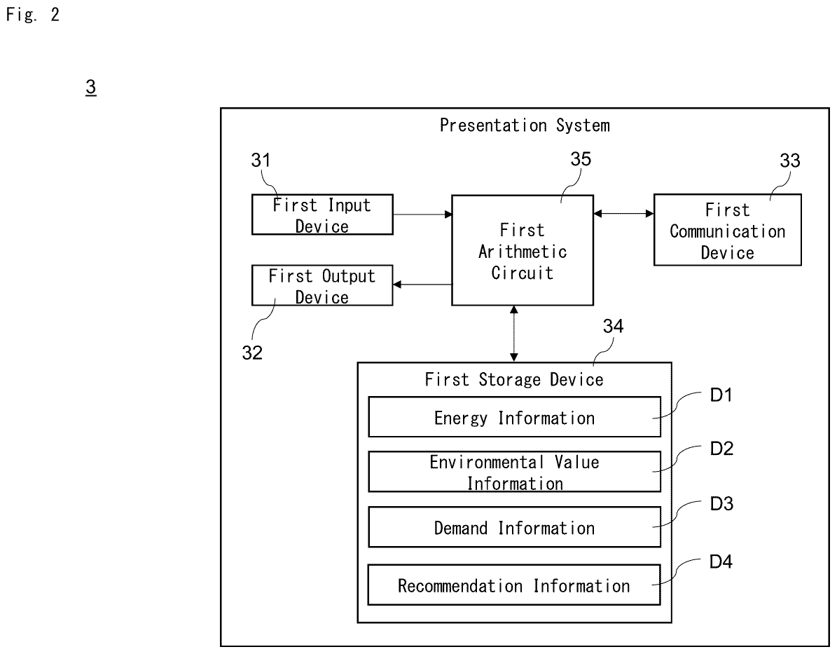

The presentation system 3 is used to present a combination plan of an energy plan and an environmental value plan which matches demand of the user 5. The presentation system 3 is communicably connected to the information source 2 via a communication network. FIG. 2 is a block diagram of the presentation system 3. The presentation system 3 includes a first input device 31, a first output device 32, a first communication device 33, a first storage device 34, and a first arithmetic circuit 35. The presentation system 3 can be realized by one or more servers and the like, for example.

The first input device 31 includes one or more human-machine interfaces for inputting information. Examples of human-machine interfaces include input interfaces such as a keyboard, pointing devices (e.g., mouse, trackball), touchpad, or positional input devices of a touch panel display. One or more human-machine interfaces of the first input device 31 may be built into the presentation system 3 or may be external. That is, the first input device 31 may include human-machine interfaces of the presentation system 3 itself and human-machine interfaces connected to the presentation system 3.

The first output device 32 includes one or more human-machine interfaces for outputting information. Examples of human-machine interfaces include output interfaces such as a display, speaker, or display devices of a touch panel display. One or more human-machine interfaces of the first output device 32 may be built into the presentation system 3 or may be external. That is, the first output device 32 may include human-machine interfaces of the presentation system 3 itself and human-machine interfaces connected to the presentation system 3.

The first communication device 33 is used for communication via a communication network. The communication network may include the Internet and may include not only a network conforming to a single communication protocol but also a plurality of networks conforming to different communication protocols. The communication protocols may be selected from various known wired and wireless communication standards. Examples of wired communication standards include standards such as Ethernet (registered trademark). Examples of wireless communication standards include standards such as IEEE 802.11. The communication network may include data communication devices such as repeater hubs, switching hubs, bridges, gateways, or routers. The first communication device 33 includes one or more communication interfaces. The first communication device 33 can be connected to a communication network and has a function to communicate via the communication network.

The first storage device 34 includes one or more storages (non-transitory storage media). The storages may be, for example, any of a hard disk drive, optical drive, or solid-state drive (SSD). Further, the storages may be any of built-in, external, or network-attached storage (NAS) type.

The information stored in the first storage device 34 includes the energy information D1, the environmental value information D2, the demand information D3, and the recommendation information D4. The energy information D1, the environmental value information D2, the demand information D3, and the recommendation information D4 do not necessarily need to be constantly stored in the first storage device 34, but may be stored in the first storage device 34 when required by the first arithmetic circuit 35.

The first arithmetic circuit 35 is connected to the first input device 31, the first output device 32, and the first communication device 33, and is accessible to the first storage device 34. The first arithmetic circuit 35 may be implemented, for example, by a computer system. The computer system includes one or more processors (microprocessors) and one or more memories. By executing a program (stored in one or more memories or in the first storage device 34) by the one or more processors, various functions of the presentation system 3 are realized. The program may be recorded in advance in the first storage device 34, or may be provided via electrical communication lines such as the Internet or recorded on non-transitory storage media such as a memory card.

The first arithmetic circuit 35 is configured to acquire the energy information D1 and store it in the first storage device 34.

The energy information D1 includes information regarding a history of prices of the plurality of energy plans. The plurality of energy plans may be proposed not by a single energy provider but by multiple different energy providers. In the present embodiment, the plurality of energy plans include a fixed price energy plan in which an energy price is constant, and a variable price energy plan in which an energy price fluctuates. The plurality of energy plans includes a plurality of fixed energy plans and a plurality of variable energy plans. A fixed energy plan is an energy plan in which an energy supply quantity is constant. The fixed energy plan uses non-renewable energy produced by fossil-fuel power generation, nuclear power generation, or the like, and thus the energy supply quantity can be kept constant. The variable energy plan is an energy plan in which an energy supply quantity fluctuates due to usage of renewable energy. Adopting the variable energy plan enables improvement of the ratio of non-fossil fuels for electricity generation. The plurality of energy plans are classified as either fixed price energy plans or variable price energy plans in terms of price, and as either fixed energy plans or variable energy plans in terms of supply quantity.

For example, the first arithmetic circuit 35 may acquire the energy information D1 by accessing the energy provider server 23 via the first communication device 33 to collect information regarding the history of prices of energy plans.

The first arithmetic circuit 35 is configured to acquire the environmental value information D2 and store it in the first storage device 34.

The environmental value information D2 includes information regarding a history of prices of the plurality of environmental value plans. The plurality of environmental value plans may be proposed not by a single environmental value provider but by multiple different environmental value providers. In the present embodiment, the plurality of environmental value plans includes a fixed price environmental value plan in which an environmental value price is constant, and a variable price environmental value plan in which an environmental value price fluctuates. That is, the plurality of environmental value plans are classified as either fixed price environmental value plans or variable price environmental value plans.

For example, the first arithmetic circuit 35 may acquire the environmental value information D2 by accessing the environmental value provider server 24 via the first communication device 33 to collect the information regarding the history of prices of environmental value plans.

The first arithmetic circuit 35 is configured to acquire the demand information D3 and store it in the first storage device 34.

The demand information D3 includes an energy demand and an environmental target. The energy demand and the environmental target are determined by the user 5. The energy demand may be, for example, the amount of energy over a certain period. The certain period may be, for example, a year or a month. In the present embodiment, the first arithmetic circuit 35 is communicably connected to the measurement equipment 21 and the renewable energy equipment 22 via the first communication device 33. The first arithmetic circuit 35 is accessible to consumption information regarding a history of an energy usage acquired from the measurement equipment 21. The first arithmetic circuit 35 can determine the energy demand based on the consumption information. The first arithmetic circuit 35 is also accessible to generation information regarding a history of an energy generation amount acquired from the renewable energy equipment 22. The first arithmetic circuit 35 can correct the energy demand based on the generation information. The first arithmetic circuit 35 may automatically calculate the energy demand and present it to the user 5 as a reference value. The user 5 can determine the final energy demand based on the reference value. Accordingly, the effort required to determine the energy demand can be reduced.

The demand information D3 further includes an allowable value for a risk of price fluctuation in a combination plan. The allowable value for the risk of price fluctuation defines a range of a combination plan price that user 5 can tolerate. For example, the allowable value may be expressed as the ratio (%) of the standard deviation of the combination plan price to its expected value, or as an upper limit (in yen) of the standard deviation of the combination plan price. Therefore, it is possible to easily reflect the preferences of user 5 in the combination plan.

The demand information D3 may include restriction information. The restriction information is information regarding conditions of energy plans and/or environmental value plans among the plurality of energy plans and/or the plurality of environmental value plans that are not to be used in the combination plan. In the present embodiment, the restriction information for energy plans includes information indicating whether it is possible to select between a fixed price energy plan and a variable price energy plan. The restriction information for environmental value plans includes information indicating whether it is possible to select between a fixed price environmental value plan and a variable price environmental value plan. In other words, the user 5 can designate, via the restriction information, the conditions of energy plans and/or environmental value plans that the user 5 does not wish to include in the combination plan from among the plurality of energy plans and the plurality of environmental value plans. Therefore, it is possible to easily reflect the preferences of user 5 in the combination plan.

The demand information D3 may include designation information. The designation information designates at least one or more among the plurality of energy plans and the plurality of environmental value plans. The designation information is set by the user 5. In other words, the user 5 can designate, via the designation information, which energy plan(s) and/or environmental value plan(s) among the plurality of energy plans and the plurality of environmental value plans are to be included in the combination plan. Therefore, it is possible to easily reflect the preferences of the user 5 in the combination plan.

For example, the first arithmetic circuit 35 can communicate with the information terminal 4 via the first communication device 33, and may receive from the user, through the information terminal 4, an input of part or all of the demand information D3. Details regarding the input of the demand information D3 will be described later.

The first arithmetic circuit 35, based on the energy information D1 and the environmental value information D2, presents a plurality of combination plans consisting of an energy plan and an environmental value plan that satisfy the energy demand and the environmental target specified in the demand information D3, along with an indicator value representing the risk of price fluctuation for each of the plurality of combination plans. In particular, in the present embodiment, the first arithmetic circuit 35 presents an indicator value for the price (first indicator value) and an indicator value for the risk of price fluctuation (second indicator value) for each of the plurality of combination plans. The plurality of combination plans that satisfy the energy demand and the environmental target, as well as the first indicator value for the price and the second indicator value for the risk of price fluctuation of each combination plan, are included in the recommendation information D4.

The first arithmetic circuit 35 extracts from among the plurality of energy plans and the plurality of environmental value plans, as a combination plan, a combination of an energy plan and an environmental value plan that satisfies the energy demand and the environmental target specified in the demand information D3.

In extracting the combination plan, the first arithmetic circuit 35 extracts a combination of energy plans from among the plurality of energy plans. A combination of energy plans includes a specified number of fixed energy plans and a specified number of variable energy plans. Here, the specified number of fixed energy plans and the specified number of variable energy plans are integers equal to or greater than zero, but not both zero at the same time. The specified number of fixed energy plans and the specified number of variable energy plans may be appropriately adjusted to generate any desired number of combination plans, or they may be predetermined. Alternatively, the specified number of fixed energy plans and the specified number of variable energy plans may be determined by the user 5.

The first arithmetic circuit 35 evaluates a combination of energy plans. In evaluating a combination of energy plans, the amount of environmental value required to achieve the environmental target, in cases where the combination satisfies the energy demand, is assessed.

Depending on the type of environmental value, the amount of environmental value is represented, for example, by the amount of CO₂ emissions. Based on the definitions in TABLE 1 below, the method for calculating the amount of environmental value is described. In TABLE 1, “t” represents time. Symbols including “t” denote past data. “si” represents a fixed energy plan, and “vj” represents a variable energy plan. Here, “i” is a number identifying a fixed energy plan, and “j” is a number identifying a variable energy plan. “ek” represents an environmental value plan, and “k” is a number identifying an environmental value plan.

TABLE 1

| Item | Symbol | Unit |
|---|---|---|
| Energy demand | dₜ | kWh |
| Energy supply quantity of fixed energy plan | x_{si, t} | kWh |
| Energy supply quantity of variable energy plan | x_{vj, t} | kWhP |
| Price of fixed energy plan | p_{si, t} | yen/kWh |
| Price of variable energy plan | p_{vj, t} | yen/kWh |
| Price of environmental value of environmental | pₑₖ | yen/t-CO₂ |
| value plan | | |
| CO₂ emissions factor of fixed energy plan | cₛᵢ | t-CO₂/kWh |
| CO₂ emissions factor of variable energy plan | cᵥⱼ | t-CO₂/kWh |

When a combination of energy plans satisfies the energy demand, the sum of the energy supply quantity of the fixed energy plans and the energy supply quantity of the variable energy plans is equal to the energy demand. Let Is denote the set of fixed energy plans and Iv denote the set of variable energy plans. Then, the following equation (1) holds.

$$\begin{matrix}[ MATHEMATICAL FORMULA 1 ] & \\ {d}_{t} = {\sum }_{i ∈ {I}_{s}} {x}_{s i , t} + {\sum }_{j ∈ {I}_{ν}} {x}_{vj , t} & ( 1 )\end{matrix}$$

When the ratio of the fixed energy plan is denoted by aᵢ, the energy supply quantity X_{si,t} is expressed by the following equation (2).

$$\begin{matrix}[ MATHEMATICAL FORMULA 2 ] & \\ {x}_{si , t} = {a}_{i} ( {d}_{t} - {\sum }_{j ∈ {I}_{ν}} {x}_{vj , t} ) & ( 2 )\end{matrix}$$

Accordingly, the above equation (1) can be rewritten as the following equation (3).

$$\begin{matrix}[ MATHEMATICAL FORMULA 3 ] & \\ {d}_{t} = {\sum }_{j ∈ {I}_{ν}} {x}_{vj , t} + {\sum }_{i ∈ {I}_{s}} {a}_{i} ( {d}_{t} - {\sum }_{j ∈ {I}_{ν}} {x}_{vj , t} ) & ( 3 )\end{matrix}$$

When the amount of CO₂ emissions at time tis denoted by Et, Et is expressed by the following equation (4).

$$\begin{matrix}[ MATHEMATICAL FORMULA 4 ] & \\ {E}_{t} = {\sum }_{j ∈ {I}_{ν}} {c}_{vi} {x}_{vj , t} + {\sum }_{i ∈ {I}_{s}} {c}_{s i} {a}_{i} ( {d}_{t} - {\sum }_{j ∈ {I}_{ν}} {x}_{vj , t} ) & ( 4 )\end{matrix}$$

It is assumed that the environmental value is purchased in order to offset the CO₂ emissions over a predetermined period. The total amount of CO₂ emissions during the predetermined period T is expressed by the following equation (5).

$$\begin{matrix}[ MATHEMATICAL FORMULA 5 ] & \\ {\sum }_{t ∈ T} {E}_{t} & ( 5 )\end{matrix}$$

In this manner, it is possible to determine the amount of environmental value required to achieve the environmental target when the combination of energy plans satisfies the energy demand.

The first arithmetic circuit 35 extracts, based on the calculated amount of environmental value, a combination of environmental value plans from among the plurality of environmental value plans. The combination of environmental value plans includes a specified number of fixed price environmental value plans and a specified number of variable-price environmental value plans. Here, the specified number of fixed-price environmental value plans and the specified number of variable-price environmental value plans are integers equal to or greater than zero, but not both zero at the same time. The specified number of the fixed-price environmental value plans and the specified number of the variable price environmental value plans may be appropriately adjusted to generate any desired number of combination plans, or may be predetermined. Alternatively, the specified number of the fixed price environmental plans and the specified number of variable price environmental value plans may be determined by the user 5.

Hereinafter, examples of the combination plan will be described.

A first example of the combination plan includes one of the plurality of fixed energy plans but does not include any of the plurality of environmental value plans. When the environmental target can be achieved by a single fixed energy plan, it is not necessary to combine any environmental value plan. The first example of the combination plan can simplify the content of the combination plan. Accordingly, the user 5 can, for example, achieve the environmental target while satisfying the energy demand through a simple contract.

A second example of the combination plan includes one of the plurality of fixed energy plans and one of the plurality of environmental value plans. The second example of the combination plan can simplify the content of the combination plan. Accordingly, the user 5 can, for example, achieve the environmental target while satisfying the energy demand through a simple contract.

A third example of the combination plan includes one of the plurality of fixed energy plans and one of the plurality of variable energy plans. When the environmental target can be achieved through a combination of a fixed energy plan and a variable energy plan, it is not necessary to combine any environmental value plan. By adopting a variable energy plan, the ratio of non-fossil fuels for electricity generation can be improved. Therefore, the third example of the combination plan enables a reduction in the cost associated with purchasing environmental values. The third example of the combination plan can also simplify the content of the combination plan.

A fourth example of the combination plan includes one of the plurality of fixed energy plans, one of the plurality of variable energy plans, and one of the plurality of environmental value plans. By adopting a variable energy plan, the ratio of non-fossil fuels for electricity generation can be improved. Accordingly, the fourth example of the combination plan enables a reduction in the cost associated with purchasing environmental values. The fourth example of the combination plan can also simplify the content of the combination plan.

A fifth example of the combination plan includes two or more of the plurality of variable energy plans. When the environmental target can be achieved through a combination of two or more variable energy plans, it is not necessary to combine any environmental value plan. When a single variable energy plan cannot satisfy the energy demand, combining multiple variable energy plans to meet the energy demand can increase the ratio of non-fossil fuels for electricity generation. The fifth example of the combination plan enables both a reduction in the cost associated with purchasing environmental values and stabilization of the energy supply. The fifth example of the combination plan can also simplify the content of the combination plan. Here, it is preferable that the two or more variable energy plans have a third indicator value of a correlation between energy supply quantities that is equal to or less than a threshold value. This makes it possible to further stabilize the energy supply. The third indicator value may be a covariance of the energy supply quantities, which enables simplification of the calculation of the third indicator value.

A sixth example of the combination plan includes two or more of the plurality of variable energy plans and one of the plurality of environmental value plans. The sixth example of the combination plan enables both a reduction in the cost associated with purchasing environmental values and stabilization of the energy supply. The sixth example of the combination plan can also simplify the content of the combination plan.

In the fifth and sixth examples, it is preferable that the total energy supply quantity from the variable energy plans always exceeds the energy demand, or that a decrease in the energy supply quantity can be compensated by storing surplus energy.

A seventh example of the combination plan includes two or more of the plurality of fixed energy plans in which an energy supply quantity is constant but a price fluctuates. When the environmental target can be achieved by multiple fixed energy plans, it is not necessary to combine any environmental value plan. The seventh example of the combination plan enables reduction of the risk of price fluctuation associated with the fixed energy plans. The seventh example of the combination plan can also simplify the content of the combination plan. Here, it is preferable that the two or more fixed energy plans have a fourth indicator value of a correlation between energy prices that is equal to or less than a threshold value. This enables further reduction of the risk of price fluctuation associated with the fixed energy plans. The fourth indicator value may be a covariance of the energy prices, which enables simplification of the calculation of the fourth indicator value.

An eighth example of the combination plan includes two or more of the plurality of fixed energy plans in which an energy supply quantity is constant but a prices fluctuates, and one of the plurality of environmental value plans. The eighth example of the combination plan enables reduction of the risk of price fluctuation associated with the fixed energy plans. The eighth example of the combination plan can also simplify the content of the combination plan.

A ninth example of the combination plan further includes, in addition to one or a combination of the plurality of energy plans, two or more of the plurality of variable price environmental value plans. The ninth example of the combination plan enables reduction of the risk of price fluctuation associated with the variable price environmental value plans. Here, it is preferable that the two or more variable price environmental value plans have a fifth indicator value of a correlation between environmental value prices that is equal to or less than a threshold value. This enables further reduction of the risk of price fluctuation associated with the variable price environmental value plans. The fifth indicator value may be a covariance of the environmental value prices, which enables simplification of the calculation of the fifth indicator value. The combination of one or the plurality of energy plans may be any of the combinations described in the first to eighth examples of the combination plan.

As described above, the first arithmetic circuit 35 determines the combination plan. The first arithmetic circuit 35 calculates, with respect to the combination plan, a first indicator value representing the price of the combination plan and a second indicator value representing the risk of price fluctuation.

The first indicator value of the price of the combination plan is a value presented to the user 5 as the price of the combination plan. The price of the combination plan is not necessarily constant and may fluctuate. The first indicator value may be a statistical value of the price of the combination plan, and in the present embodiment, it is an expected value of the price of the combination plan.

The second indicator value of the risk of price fluctuation of the combination plan is a value presented to the user 5 as the risk of price fluctuation of the combination plan. The price fluctuation of the combination plan is affected by fluctuations in the prices of the energy plans and/or environmental value plans included in the combination plan. When the risk of price fluctuation is large, the user 5 may be required to make an unexpected payment. The second indicator value may be a statistical value indicating the degree of price fluctuation of the combination plan, and in the present embodiment, it is the standard deviation of the price of the combination plan. Since the standard deviation and variance can be regarded as substantially the same, the variance of the price of the combination plan may be used as the second indicator value.

Hereinafter, how to calculate the first indicator value and the second indicator value will be described. Let P1ₜ denote the price of the combination of energy plans at time t. Using the above equation (3), P1ₜ is expressed by the following equation (6).

$$\begin{matrix}[ MATHEMATICAL FORMULA 6 ] & \\ P {1}_{t} = {\sum }_{j ∈ {I}_{ν}} {p}_{vj , t} {x}_{vj , t} + {\sum }_{i ∈ {I}_{s}} {p}_{si , t} {a}_{i} ( {d}_{t} - {\sum }_{j ∈ {I}_{ν}} {x}_{vj , t} ) & ( 6 )\end{matrix}$$

Let P2ₜ denote the price of the environmental value plan. Let Iₖ denote the set of environmental value plans, and let bₖ denote the ratio of each environmental value plan. Using the above equation (5), the price P2; of the environmental value plan is expressed by the following equation (7).

$$\begin{matrix}[ MATHEMATICAL FORMULA 7 ] & \\ P {2}_{t} = {\sum }_{k ∈ {I}_{k}} {p}_{e k} {b}_{k} {\sum }_{t ∈ T} {E}_{t} & ( 7 )\end{matrix}$$

Let Pₜ denote the price of the combination plan. Then, Pₜ=P1ₜ+P2ₜ. From the information regarding the history of prices of the plurality of energy plans included in the energy information D1 and the information regarding the history of prices of the plurality of environmental value plans included in the environmental value information D2, a probability distribution of the price Pₜ of the combination plan can be acquired. Accordingly, from the probability distribution of the price Pₜ of the combination plan, the expected value and the standard deviation of the price Pₜ can be determined as the first indicator value and the second indicator value, respectively. It is preferable that the ratios aᵢ and bₖ be optimized so that the first indicator value and the second indicator value are minimized.

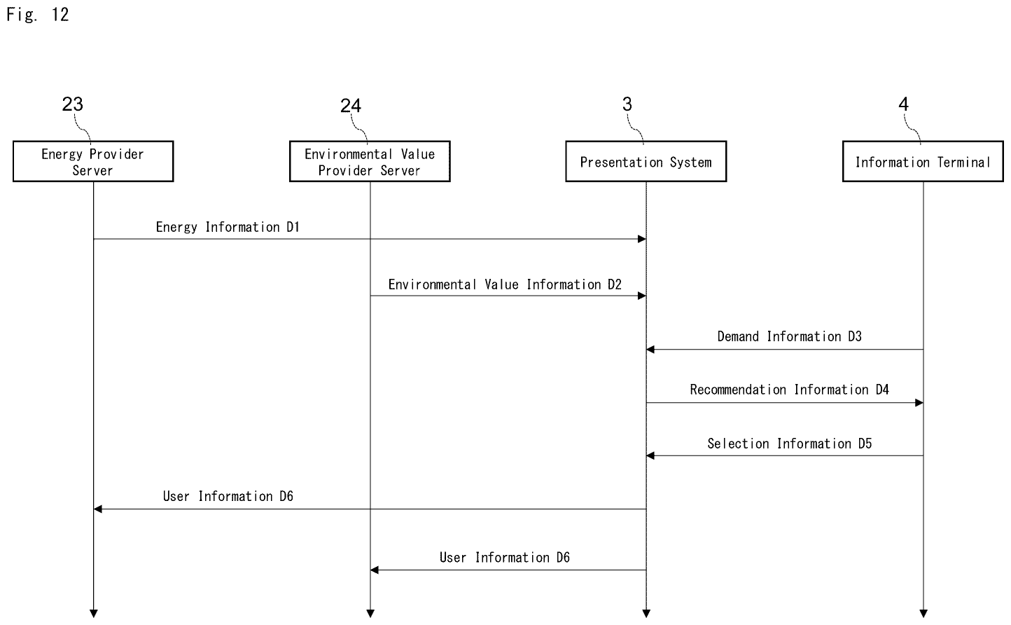

The first arithmetic circuit 35, after providing the recommendation information D4 to the information terminal 4, can receive selection information D5 (see FIG. 12) from the information terminal 4. The selection information D5 selects one of the plurality of combination plans. The selection information D5 may be transmitted from the information terminal 4 to the presentation system 3 in response to the user 5 selecting one of the plurality of combination plans included in the recommendation information D4 presented on the information terminal 4. When the first arithmetic circuit 35 receives the selection information D5, it provides user information D6 (see FIG. 12) associated with the selection information D5 to the energy provider and the environmental value provider respectively associated with the energy plan and the environmental value plan included in the combination plan selected by the selection information D5. In the present embodiment, the first arithmetic circuit 35 provides the user information D6 associated with the selection information D5 to the energy provider server 23 and the environmental value provider server 24, which are respectively associated with the energy plan and the environmental value plan included in the combination plan selected by the selection information D5. The user information D6 may include information that allows the energy provider and the environmental value provider to contact the user 5. For example, the user information D6 may include contact information such as the user's address, residence, telephone number, and email address.

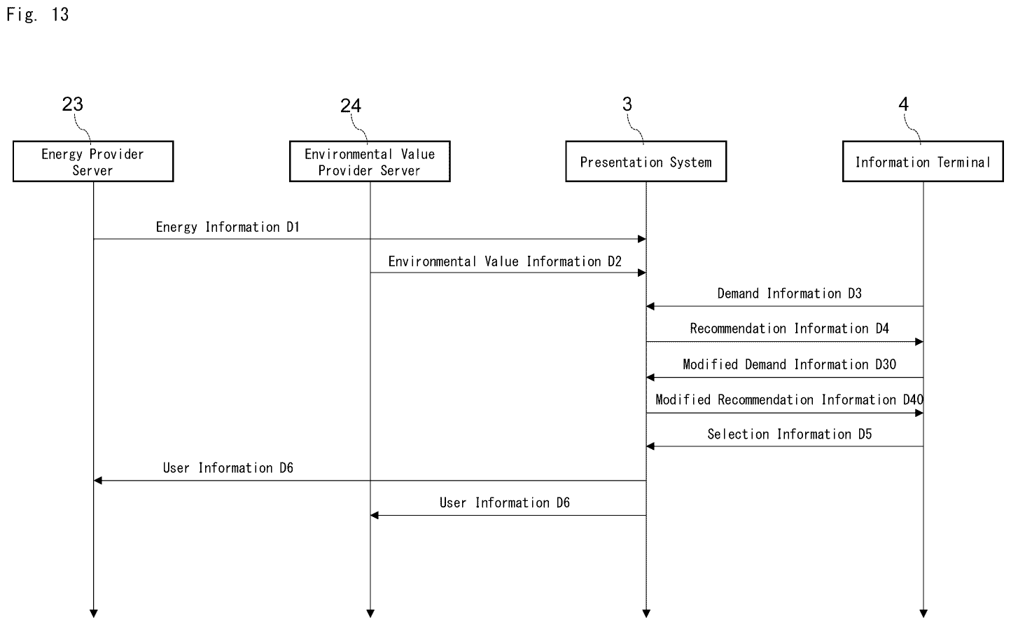

The first arithmetic circuit 35, after providing the recommendation information D4 to the information terminal 4, can receive modified demand information D30 (see FIG. 13) from the information terminal 4. The modified demand information D30 is demand information D3 in which at least one of the energy demand and the environmental target has been modified. The modified demand information D30 may be transmitted from the information terminal 4 to the presentation system 3 in response to the user 5 modifying at least one of the energy demand and the environmental target included in the demand information D3. When the first arithmetic circuit 35 receives the modified demand information D30, it presents a plurality of modified combination plans, which satisfy the energy demand and the environmental target specified in the demand information D3, based on the energy information D1 and the environmental value information D2, together with an indicator value representing the risk of price fluctuation for each of the plurality of modified combination plans. In particular, in the present embodiment, the first arithmetic circuit 35 can present, for each of the plurality of modified combination plans, an indicator value of the price (the first indicator value) and an indicator value of the risk of price fluctuation (the second indicator value). The plurality of modified combination plans that satisfy the energy demand and the environmental target, and the first indicator value of the price and the second indicator value of the risk of price fluctuation for each of the plurality of modified combination plans, are included in modified recommendation information D40 (see FIG. 13). The first arithmetic circuit 35 can transmit the modified recommendation information D40 to the information terminal 4.

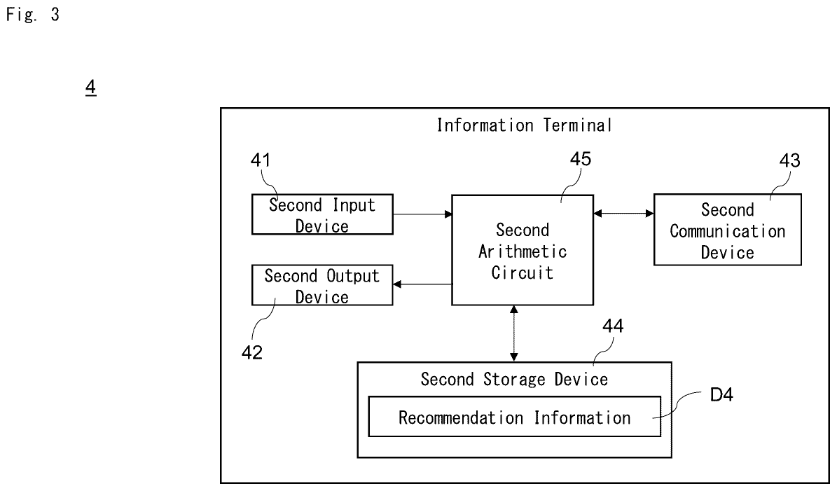

The information terminal 4 is communicably connected to the presentation system 3 via the communication network. The information terminal 4 is used for input of information by the user 5 (mainly the demand information D3 and the modified demand information D30) and for presentation of information to the user 5 (mainly the recommendation information D4 and the modified recommendation information D40). The information terminal 4 has a function of displaying a screen for transmission and reception of information with the presentation system 3, and serves as a graphical user interface (GUI). FIG. 3 is a block diagram of the information terminal 4. The information terminal 4 includes a second input device 41, a second output device 42, a second communication device 43, a second storage device 44, and a second arithmetic circuit 45. The information terminal 4 may be implemented, for example, by a personal computer (a desktop computer or laptop computer) or a mobile terminal (such as a smartphone or tablet device). The configurations of the second input device 41, the second output device 42, the second communication device 43, the second storage device 44, and the second arithmetic circuit 45 are similar to those of the first input device 31, the first output device 32, the first communication device 33, the first storage device 34, and the first arithmetic circuit 35.

### 1.2 Operations

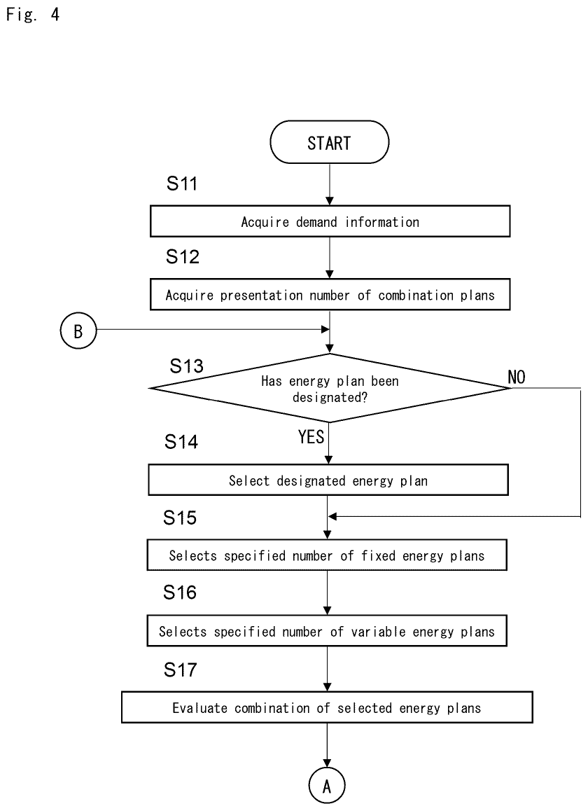

Hereinafter, one example of the operation of the presentation system 3 will be described. FIGS. 4 to 6 are flowcharts of part of the operation of the presentation system 3, respectively.

Referring to FIG. 4, the first arithmetic circuit 35 acquires the demand information D3 (S11). A part or all of the demand information D3 is input by the user 5 using the information terminal 4. In order to receive the demand information D3 from the user 5, the first arithmetic circuit 35 cooperates with the second arithmetic circuit 45 of the information terminal 4 to present an input screen on the second output device 42.

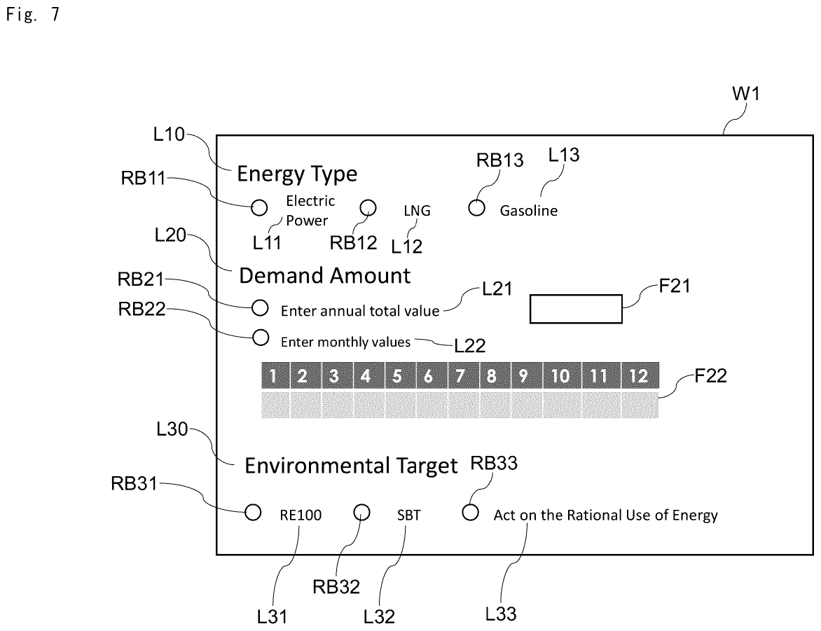

FIGS. 7 to 10 are schematic diagrams of parts of input screens for the demand information D3.

FIG. 7 shows an input window W1 for input of the energy type, the energy demand, and the environmental target.

The input window W1 includes item labels L10, L20, and L30; selection buttons RB11-RB13, RB21, RB22, and RB31-RB33; option labels L11-L13, L21, L22, and L31-L33; and input fields F21 and F22.

The item label L10 corresponds to the item “energy type” and displays the text “Energy Type” representing the corresponding item. The selection buttons RB11-RB13 are buttons for selecting an energy type, and are radio buttons allowing the selection of one of multiple options. The selection buttons RB11-RB13 respectively correspond to electric power, LNG, and gasoline. The option labels L11-L13 are arranged near the selection buttons RB11-RB13, and respectively display the text “Electric Power,” “LNG,” and “Gasoline.”

In the input window W1, the user 5 can select the energy type from electric power, LNG, and gasoline using the selection buttons RB11-RB13.

The item label L20 corresponds to the item “energy demand” and displays the text “Demand Amount” representing the corresponding item. The selection buttons RB21 and RB22 are buttons for selecting how to input the energy demand, and are radio buttons that allow selection of one of two options. The selection button RB21 corresponds to the annual energy demand, and the selection button RB22 corresponds to the monthly energy demand for one year. The option labels L21 and L22 are arranged near the selection buttons RB21 and RB22. The option label L21 displays text such as “Enter annual total value,” and the option label L22 displays text such as “Enter monthly values.” The input field F21 is arranged near the option label L21 and accepts input of the annual energy demand. The input field F22 is arranged near the option label L22 and accepts input of the monthly energy demand for one year. The input fields F21 and F22 may display, in advance, reference values of the energy demand calculated by the first arithmetic circuit 35.

In the input window W1, the user 5 can input the energy demand using the selection buttons RB21, RB22, and the input fields F21 and F22.

The item label L30 corresponds to the item “environmental target” and displays the text “environmental target” representing the corresponding item. The selection buttons RB31-RB33 are buttons for selecting the environmental target, and are radio buttons that allow selection of one of multiple options. The selection buttons RB31-RB33 respectively correspond to RE100, SBT, and the Act on the Rational Use of Energy. The option labels L31-L33 are arranged near the selection buttons RB31-RB33, and respectively display the text “RE100,” “SBT,” and “Act on the Rational Use of Energy.”

In the input window W1, the user 5 can select the environmental target from RE100, SBT, and the Act on the Rational Use of Energy using the selection buttons RB31-RB33.

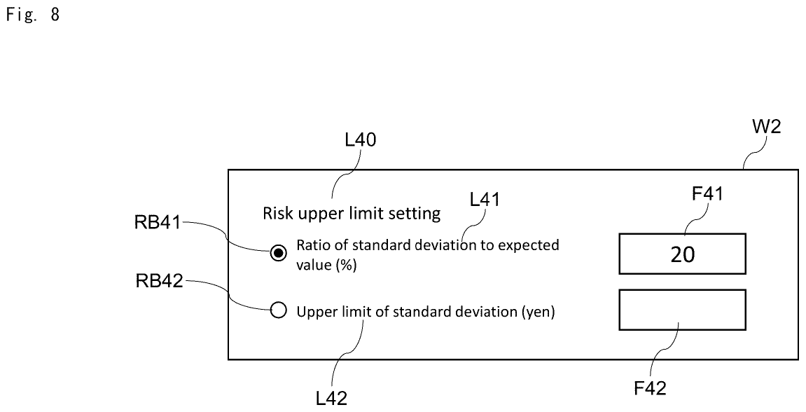

FIG. 8 shows an input window W2 for inputting an allowable value of the risk of price fluctuation of the combination plan. The input window W2 includes an item label L40, selection buttons RB41 and RB42, option labels L41 and L42, and input fields F41 and F42.

The item label L40 corresponds to the item “allowable value of the risk of price fluctuation” and displays the text “Risk upper limit setting” representing the corresponding item. The selection buttons RB41 and RB42 are buttons for selecting how to input the allowable value, and are radio buttons that allow selection of one of the options. The selection button RB41 corresponds to a method in which the allowable value is input as the ratio (%) of the standard deviation of the price to the expected value of the price of the combination plan. The selection button RB42 corresponds to a method in which the allowable value is input as the upper limit (yen) of the standard deviation of the price of the combination plan. The option labels L41 and L42 are arranged near the selection buttons RB41 and RB42. The option label L41 displays text such as “Ratio of standard deviation to expected value (%)”, and the option label L42 displays text such as “Upper limit of standard deviation (yen).” The input field F41 is arranged near the option label L41 and accepts input of the ratio (%) of the standard deviation of the price to the expected value of the price of the combination plan. The input field F42 is arranged near the option label L42 and accepts input of the upper limit (yen) of the standard deviation of the price of the combination plan.

In the input window W2, the user 5 can input the allowable value using the selection buttons RB41 and RB42 and the input fields F41 and F42.

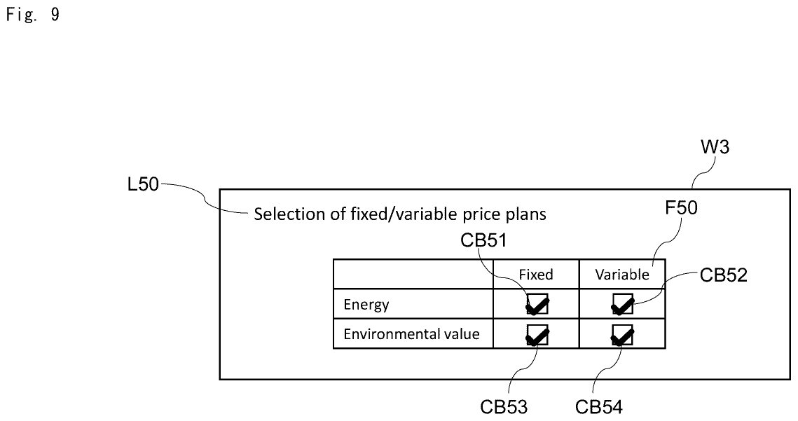

FIG. 9 shows an input window W3 for inputting the restriction information. The input window W3 includes an item label L50 and an input field F50.

The item label L50 corresponds to the item “restriction information” and displays the text “Selection of fixed/variable price plans” representing the corresponding item. The input field F50 allows input regarding whether each of the fixed price energy plan, variable price energy plan, fixed-price environmental value plan, and variable-price environmental value plan can be selected. The input field F50 presents a table including rows of “Energy” and “Environmental value,” and columns of “Fixed” and “Variable.” In the cell specified by “Energy” and “Fixed,” a checkbox CB51 is arranged, and whether the checkbox CB51 is checked indicates whether selection of the fixed price energy plan is permitted. In the cell specified by “Energy” and “Variable,” a checkbox CB52 is arranged, and whether the checkbox CB52 is checked indicates whether selection of the variable price energy plan is permitted. In the cell specified by “Environmental value” and “Fixed,” a checkbox CB53 is arranged, and whether the checkbox CB53 is checked indicates whether selection of the fixed-price environmental value plan is permitted. In the cell specified by “Environmental value” and “Variable,” a checkbox CB54 is arranged, and whether the checkbox CB54 is checked indicates whether selection of the variable-price environmental value plan is permitted. By default, the checkboxes CB51 to CB54 may be checked.

In the input window W3, the user 5 can input the restriction information using the checkboxes CB51 to CB54 in the input field F50.

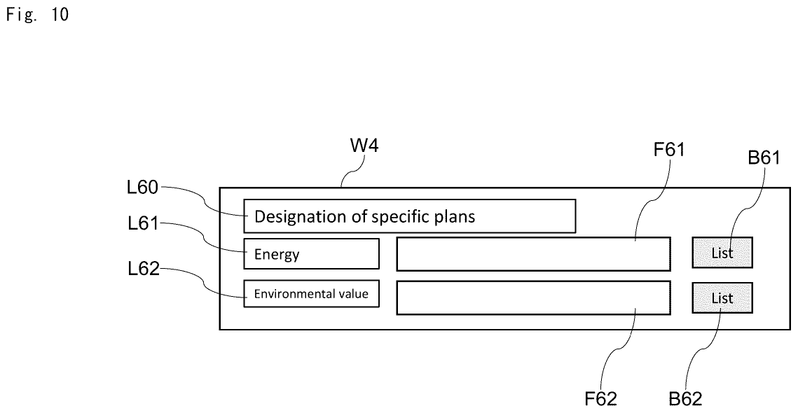

FIG. 10 shows an input window W4 for inputting designation information. The input window W4 includes an item label L60, display labels L61 and L62, input fields F61 and F62, and reference buttons B61 and B62.

The item label L60 corresponds to the item “designation information” and displays the text “Designation of specific plans” representing the corresponding item. The display labels L61 and L62 indicate the type of plan to be designated, namely, whether it is an energy plan or an environmental value plan. The display label L61 displays the text “Energy,” and the display label L62 displays the text “Environmental value.” The input field F61 is arranged near the display label L61 and accepts input of the designated energy plan. The reference button B61 is arranged near the input field F61 and accepts display of a list of selectable energy plans and selection of a designated energy plan. The input field F62 is arranged near the display label L62 and accepts input of the designated environmental value plan. The reference button B62 is arranged near the input field F62 and accepts display of a list of selectable environmental value plans and selection of a designated environmental value plan.

In the input window W4, the user 5 can input the designation information using the input fields F61 and F62.

Referring again to FIG. 4, the first arithmetic circuit 35 acquires a presentation number of combination plans (S12). The presentation number of combination plans defines the number of combination plans to be presented to the user 5. The presentation number of combination plans is input by the user 5 using the information terminal 4. In order to receive the presentation number of combination plans from the user 5, the first arithmetic circuit 35 may cooperate with the second arithmetic circuit 45 of the information terminal 4 to present, on the second output device 42, an input screen for inputting the presentation number of combination plans.

The first arithmetic circuit 35 refers to the designation information included in the demand information D3 and determines whether an energy plan has been designated (S13).

In step S13, when an energy plan has been designated (S13: YES), the first arithmetic circuit 35 selects the designated energy plan (S14).

As a result, the designated energy plan is included in the combination plan.

The first arithmetic circuit 35 selects a specified number of fixed energy plans and includes them in the combination plan (S15).

The first arithmetic circuit 35 selects a specified number of variable energy plans and includes them in the combination plan (S16).

The first arithmetic circuit 35 evaluates the combination of the selected energy plans (S17). Through the evaluation of the combined energy plans, the amount of CO₂ emissions required to achieve the environmental target is acquired.

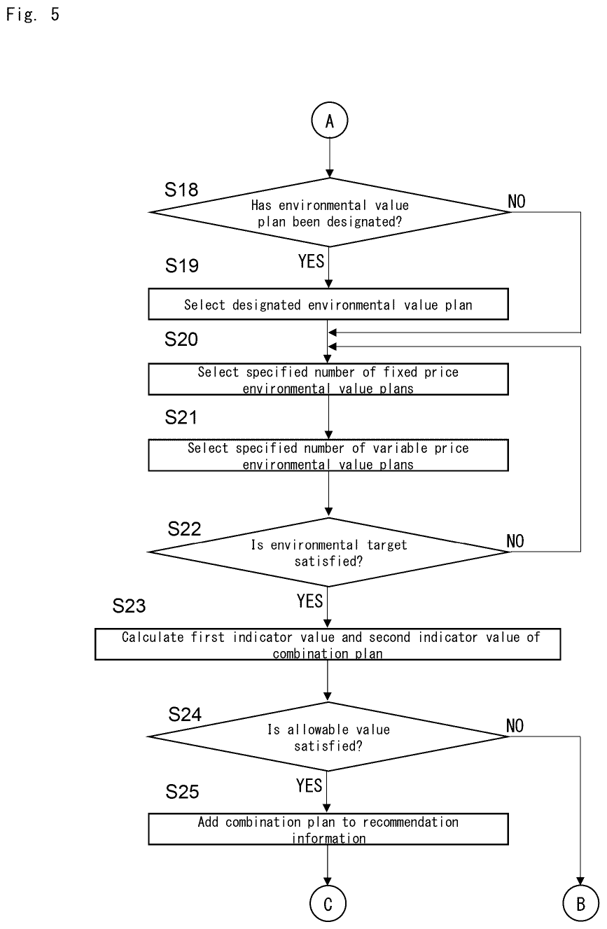

Referring to FIG. 5, the first arithmetic circuit 35 refers to the designation information included in the demand information D3 and determines whether an environmental value plan has been designated (S18).

In step S18, when an environmental value plan has been designated (S18: YES), the first arithmetic circuit 35 selects the designated environmental value plan (S19). As a result, the designated environmental value plan is included in the combination plan.

The first arithmetic circuit 35 selects a specified number of fixed price environmental value plans and includes them in the combination plan (S20).

The first arithmetic circuit 35 selects a specified number of variable price environmental value plans and includes them in the combination plan (S21).

The first arithmetic circuit 35 determines whether the combination of the selected environmental value plans can achieve the environmental target (S22). Specifically, it determines whether the combination of the selected environmental value plans can satisfy the amount of CO₂ emissions required to achieve the environmental target.

In step S22, when the combination of the selected environmental value plans cannot achieve the environmental target (S22: NO), the process returns to step S20, and the first arithmetic circuit 35 starts generation of a new combination of environmental value plans.

In step S22, when the combination of the selected environmental value plans can achieve the environmental target (S22: YES), the first arithmetic circuit 35 calculates the first indicator value and the second indicator value of the combination plan (S23).

The first arithmetic circuit 35 determines whether the first indicator value and the second indicator value of the combination plan satisfy the allowable value (S24).

In step S24, when the first indicator value and the second indicator value of the combination plan do not satisfy the allowable value (S24: NO), the process returns to step S13, and the first arithmetic circuit 35 starts generation of a new combination plan.

In step S24, when the first indicator value and the second indicator value of the combination plan satisfy the allowable value (S24: YES), the first arithmetic circuit 35 adds the combination plan to the recommendation information D4 (S25).

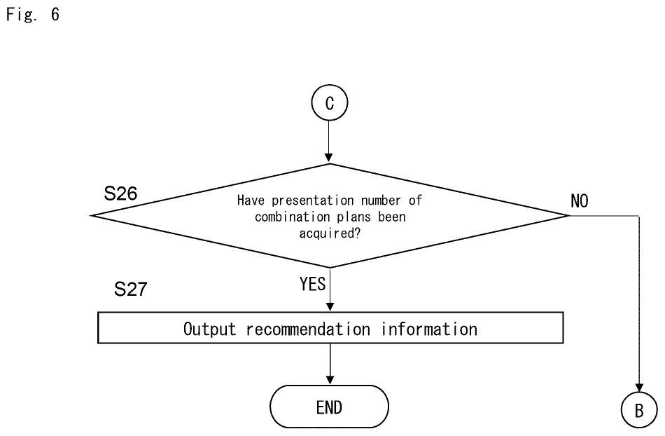

Referring to FIG. 6, the first arithmetic circuit 35 determines whether the presentation number of combination plans have been acquired (S26).

In step S26, when the presentation number of combination plans have not been acquired (S26: NO), the process returns to step S13, and the first arithmetic circuit 35 starts generation of a new combination plan.

In step S26, when the presentation number of combination plans have been acquired (S26: YES), the first arithmetic circuit 35 outputs the recommendation information D4 (S27). In order to present the recommendation information D4 to the user 5, the first arithmetic circuit 35 cooperates with the second arithmetic circuit 45 of the information terminal 4 to present an output screen on the second output device 42.

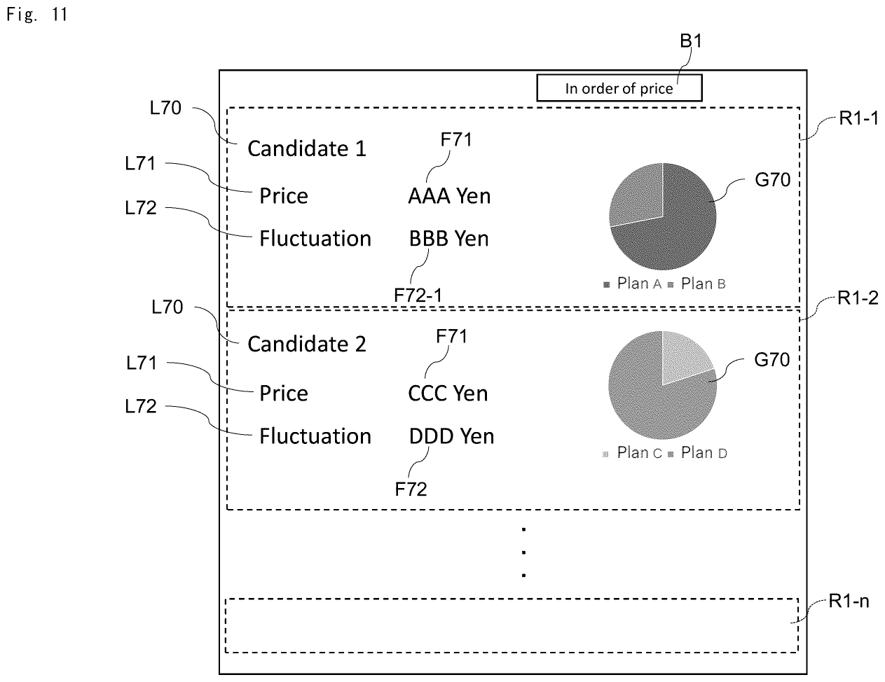

FIG. 11 is a schematic diagram of an output screen for presentation of the recommendation information D4. The output screen includes display regions R1-1, R1-2, . . . , R1-n for the combination plans and a button B1.

Each display region R1 includes name labels L70, L71, and L72; output fields F71 and F72; and a graph G70. The name label L70 displays identification information of the combination plan displayed in the display region R1. In the display region R1-1, the name label L70 displays the text “Candidate 1.” The name labels L71 and L72 display the text “Price,” corresponding to the first indicator value, and “Fluctuation,” corresponding to the second indicator value, respectively. The output field F71 is arranged near the name label L71 and displays the first indicator value of the corresponding combination plan. The output field F72 is arranged near the name label L72 and displays the second indicator value of the corresponding combination plan. The graph G70 shows the breakdown of the price of the combination plan, that is, the ratio of prices of the energy plan and the environmental value plan included in the combination plan. The graph G70 may be, for example, a pie chart.

The button B1 is used to rearrange the display of the display regions R1-1, R1-2, . . . , R1-n. The button B1 may be, for example, a pull-down menu that allows the display regions R1-1, R1-2, . . . , R1-n to be rearranged in order of descending or ascending price, or in order of descending or ascending risk of price fluctuation.

Next, examples of the operation of the recommendation system 1 will be described. FIG. 12 is a sequence diagram of a first example of the operation of the recommendation system 1.

The presentation system 3 acquires the energy information D1 by accessing the energy provider server 23 and collecting information regarding the history of prices of energy plans. The presentation system 3 acquires the environmental value information D2 by accessing the environmental value provider server 24 and collecting information regarding the history of prices of environmental value plans.

The information terminal 4 transmits the demand information D3, which has been input by the user 5, to the presentation system 3.

The presentation system 3 receives the demand information D3 from the information terminal 4. Based on the energy information D1 and the environmental value information D2, the presentation system 3 generates the recommendation information D4 including a plurality of combination plans of an energy plan and an environmental value plan that satisfy the energy demand and the environmental target specified in the demand information D3, as well as the first indicator value of the price and the second indicator value of the risk of price fluctuation for each of the plurality of combination plans, and transmits the recommendation information D4 to the information terminal 4.

The information terminal 4 receives the recommendation information D4 from the presentation system 3 and presents it to the user 5. The user 5 can select one of the plurality of combination plans included in the recommendation information D4 based on the preference of the user 5. When a combination plan is selected by the user 5, the information terminal 4 transmits selection information D5 to the presentation system 3. The selection information D5 is associated with the user information D6.

The presentation system 3 receives the selection information D5 from the information terminal 4. The presentation system 3 transmits the user information D6 associated with the selection information D5 to the energy provider server 23 and the environmental value provider server 24, which are respectively associated with the energy plan and the environmental value plan included in the combination plan selected by the selection information D5.

The energy provider associated with the energy provider server 23 can contact the user 5 based on the user information D6. Accordingly, the user 5 can proceed with the contract for the energy plan without having to contact the energy provider directly.

The environmental value provider associated with the environmental value provider server 24 can contact the user 5 based on the user information D6. Accordingly, the user 5 can proceed with the contract for the environmental value plan without having to contact the environmental value provider directly.

FIG. 13 is a sequence diagram of a second example of the operation of the recommendation system 1.

The presentation system 3 acquires the energy information D1 by accessing the energy provider server 23 and collecting information regarding the history of prices of energy plans. The presentation system 3 acquires the environmental value information D2 by accessing the environmental value provider server 24 and collecting information regarding the history of prices of environmental value plans.

The information terminal 4 transmits the demand information D3, which has been input by the user 5, to the presentation system 3.

The presentation system 3 receives the demand information D3 from the information terminal 4. Based on the energy information D1 and the environmental value information D2, the presentation system 3 generates the recommendation information D4 including a plurality of combination plans of an energy plan and an environmental value plan that satisfy the energy demand and the environmental target specified in the demand information D3, as well as the first indicator value of the price and the second indicator value of the risk of price fluctuation for each of the plurality of combination plans, and transmits the recommendation information D4 to the information terminal 4.

The information terminal 4 receives the recommendation information D4 from the presentation system 3 and presents it to the user 5. When the user 5 finds that there is no preferred combination plan among the plurality of combination plans included in the recommendation information D4, the user 5 may modify at least one of the energy demand and the environmental target. The information terminal 4 transmits the modified demand information D30, which has been input by the user 5, to the presentation system 3.

When the presentation system 3 receives the modified demand information D30, it generates, based on the energy information D1 and the environmental value information D2, modified recommendation information D40 which includes a plurality of modified combination plans of an energy plan and an environmental value plan that satisfy the energy demand and the environmental target included in the modified demand information D30, as well as the first indicator value of the price and the second indicator value of the risk of price fluctuation for each of the plurality of modified combination plans, and then transmits it to the information terminal 4.

The information terminal 4 receives the modified recommendation information D40 from the presentation system 3 and presents it to the user 5. The user 5 can select one of the plurality of modified combination plans included in the modified recommendation information D40 based on the preference of the user 5. When one of the modified combination plans is selected by the user 5, the information terminal 4 transmits selection information D5 to the presentation system 3.

The presentation system 3 receives the selection information D5 from the information terminal 4. The presentation system 3 transmits the user information D6 associated with the selection information D5 to the energy provider server 23 and the environmental value provider server 24, which are respectively associated with the energy plan and the environmental value plan included in the combination plan selected by the selection information D5.

### 1.3 Advantageous Effects

The aforementioned presentation system 3 includes the first arithmetic circuit 35 accessible to the energy information D1 including information regarding a history of prices of a plurality of energy plans, the environmental value information D2 including information regarding a history of prices of a plurality of environmental value plans, and the demand information D3 including an energy demand and an environmental target. The first arithmetic circuit 35 is configured to present, based on the energy information D1 and the environmental value information D2, a plurality of combination plans of an energy plan and an environmental value plan which satisfy the energy demand and the environmental target, and an indicator value of a risk of price fluctuation for each of the plurality of combination plans. This configuration enables more appropriate selection of an energy plan and an environmental value plan.

In recent years, many energy providers have been offering various energy plans, and many environmental value providers have been offering various environmental value plans. Accordingly, the number of possible combination plans of energy plans and environmental value plans has become enormous. Therefore, for the user 5 to manually select a combination plan that matches the user's preferences from such a vast number of combination plans would require considerable effort and is hardly realistic. Furthermore, in order to accurately understand the risk of price fluctuation of a combination plan, it is necessary to analyze an enormous amount of data relating to the prices of energy plans and environmental value plans. It is practically impossible for the user 5 to perform such an analysis by themselves. The presentation system 3 can present to the user 5 a combination of an energy plan and an environmental value plan that is more suitable for the user 5 from among a larger number of energy plans and environmental value plans than could be handled by the user 5 manually selecting them. In addition, the presentation system 3 can present the risk of price fluctuation as an indicator for selecting the combination of an energy plan and an environmental value plan. This enables a significant reduction in the effort required by the user 5 to select a combination of an energy plan and an environmental value plan.

In the presentation system 3, the first arithmetic circuit 35 is configured to present the first indicator value of the price and the second indicator value of the risk of price fluctuation for each of the plurality of combination plans. This configuration enables more appropriate selection of an energy plan and an environmental value plan.

In the presentation system 3, the first indicator value is an expected value and the second indicator value is a variance or a standard deviation. This configuration enables simplification of calculation of the first and second indicator values.

In the presentation system 3, the demand information includes the allowable value for a risk of price fluctuation in a combination plan. The first indicator value and the second indicator value of each of the plurality of combination plans satisfy the allowable value. This configuration makes it easy to incorporate the preferences of the user 5 into the combination plan.

In the presentation system 3, the plurality of energy plans include a fixed price energy plan in which an energy price is constant and a variable price energy plan in which an energy price fluctuates. The demand information D3 includes energy selection information regarding whether to select the fixed price energy plan or the variable price energy plan. The plurality of combination plans do not include one of the fixed price energy plan and the variable price energy plan which has not been selected by the energy selection information. This configuration makes it easy to incorporate the preferences of the user 5 into the combination plan.

In the presentation system 3, the plurality of environmental value plans include a fixed price environmental value plan in which an environmental value price is constant and a variable price environmental value plan in which an environmental value price fluctuates. The demand information D3 includes environmental value selection information regarding whether to select the fixed price environmental value plan or the variable price environmental value plan. The plurality of combination plans do not include one of the fixed price environmental value plan and the variable price environmental value plan which has not been selected by the environmental value selection information. This configuration makes it easy to incorporate the preferences of the user 5 into the combination plan.

In the presentation system 3, the demand information D3 includes designation information designating at least one of the plurality of energy plans and the plurality of environmental value plans. Each of the plurality of combination plans includes at least one of the plurality of energy plans and the plurality of environmental value plans designated by the designation information. This configuration makes it easy to incorporate the preferences of the user 5 into the combination plan.

In the presentation system 3, the plurality of energy plans include a plurality of fixed energy plans in which an energy supply quantity is constant. At least one of the plurality of combination plans includes one of the plurality of fixed energy plans. This configuration can simplify the content of the combination plan.

In the presentation system 3, the plurality of energy plans include a plurality of fixed energy plans in which an energy supply quantity is constant and a plurality of variable energy plans in which an energy supply quantity fluctuates due to usage of renewable energy. At least one of the plurality of combination plans includes one of the plurality of fixed energy plans and one of the plurality of variable energy plans. This configuration enables a reduction in the cost associated with purchasing environmental values.

In the presentation system 3, the plurality of energy plans include a plurality of variable energy plans in which an energy supply quantity fluctuates due to usage of renewable energy. At least one of the plurality of combination plans includes two or more of the plurality of variable energy plans. This configuration enables both a reduction in the cost associated with purchasing environmental values and stabilization of the energy supply.

In the presentation system 3, the two or more of the plurality of variable energy plans in which a third indicator value of a correlation between energy supply quantities is equal to or smaller than a threshold value. This configuration makes it possible to further stabilize the energy supply.

In the presentation system 3, the third indicator value is a covariance of the energy supply quantities. This configuration enables simplification of calculation of the third indicator value.

In the presentation system 3, the plurality of energy plans include a plurality of fixed energy plans in which an energy supply quantity is constant but a price fluctuates. At least one of the plurality of combination plans includes two or more of the plurality of fixed energy plans. This configuration enables further reduction of the risk of price fluctuation associated with the fixed energy plans.

In the presentation system 3, the two or more of the plurality of fixed energy plans in which a fourth indicator value of a correlation between energy prices is equal to or smaller than a threshold value. This configuration enables further reduction of the risk of price fluctuation associated with the fixed energy plans.

In the presentation system 3, the fourth indicator value is a covariance of the energy prices. This configuration enables simplification of calculation of the fourth indicator value.

In the presentation system 3, the at least one of the plurality of combination plans does not include any of the plurality of environmental value plans or includes one of the plurality of environmental value plans. This configuration can simplify the content of the combination plan.

In the presentation system 3, the plurality of environmental value plans include a plurality of variable price environmental value plans in which a price fluctuates. The at least one of the plurality of combination plans includes two or more of the plurality of variable price environmental value plans. This configuration enables reduction of the risk of price fluctuation associated with the environmental value plans.

In the presentation system 3, the two or more of the plurality of variable price environmental value plans in which a fifth indicator value of a correlation between environmental value prices is equal to or smaller than a threshold value. This configuration enables further reduction of the risk of price fluctuation associated with the environmental value plans.

In the presentation system 3, the fifth indicator value is a covariance of the environmental value prices. This configuration enables simplification of calculation of the fifth indicator value.

In the presentation system 3, the first arithmetic circuit 35 is configured to present an input screen to receive input of the energy demand. This configuration can reduce the effort required to determine the energy demand.

In the presentation system 3, the first arithmetic circuit 35 is accessible to consumption information regarding a history of an energy usage, and is configured to determine the energy demand based on the consumption information. This configuration can reduce the effort required to determine the energy demand.

In the presentation system 3, the first arithmetic circuit 35 is configured to, when receiving selection information D5 selecting one of the plurality of combination plans, provide user information D6 associated with the selection information D5 to an energy provider and an environmental value provider respectively associated with an energy plan and an environmental value plan included in a combination plan selected by the selection information D5. This configuration can reduce the user's effort because the user no longer needs to contact the energy provider and the environmental value provider separately.

In the presentation system 3, the first arithmetic circuit 35 is configured to, when receiving modified demand information D30 in which at least one of the energy demand or the environmental target is modified, present, based on the energy information D1 and the environmental value information D2, a plurality of modified combination plans of an energy plan and an environmental value plan which satisfy the energy demand and the environmental target included in the modified demand information D30, and an indicator value of a risk of price fluctuation for each of the plurality of modified combination plans. This configuration enables more appropriate selection of an energy plan and an environmental value plan. Since only the energy plan and environmental value plan that satisfy at least one of the energy demand and the environmental target are transmitted to the presentation system 3, it is possible to save the computational resources of one or more servers or the like that implement the presentation system 3.

In the aforementioned presentation system 3, the first arithmetic circuit 35 performs the following method (presentation method). This presentation method is performed by the first arithmetic circuit 35 accessible to energy information D1 including information regarding a history of prices of a plurality of energy plans, environmental value information D2 including information regarding a history of prices of a plurality of environmental value plans, and demand information D3 including an energy demand and an environmental target, and includes presenting, based on the energy information D1 and the environmental value information D2, a plurality of combination plans of an energy plan and an environmental value plan which satisfy the energy demand and the environmental target, and an indicator value of a risk of price fluctuation for each of the plurality of combination plans. This configuration enables more appropriate selection of an energy plan and an environmental value plan.

The aforementioned program is a program for enabling the first arithmetic circuit 35 to perform the above presentation method. This configuration enables more appropriate selection of an energy plan and an environmental value plan.

### 2. Variations

Embodiments of the present disclosure are not limited to the embodiment described above. The above embodiment may be variously modified in accordance with design and other factors, provided that the objects of the present disclosure can be achieved. Hereinafter, variations of the above embodiment will be enumerated. The variations described below may be applied in appropriate combinations.

In a variation, the presentation system 3 does not necessarily need to have a function of acquiring the energy information D1 and the environmental value information D2. The energy information D1 and the environmental value information D2 may be stored in advance in the first storage device 34. The first storage device 34 may be configured as a system independent from the presentation system 3, such as a database server.

In a variation, the presentation system 3 does not necessarily need to have access to the consumption information regarding the history of energy usage, and does not need to have a function of identifying the energy demand based on the consumption information.

In a variation, the input screens and output screens may be modified as appropriate.

In a variation, unlike the embodiment described above, it is not always necessary to acquire the amount of CO₂ emissions for the combination of energy plans. For example, since non-fossil certificates are traded in units of “yen/kWh,” it is only necessary to acquire, from the combination of energy plans, the amount of energy required to offset the energy with non-fossil certificates.

In a variation, the presentation system 3 may be implemented by a computer system including a plurality of servers or the like. It is not essential that the plurality of functions (components) of the presentation system 3 be integrated within a single housing, and the components of the presentation system 3 may be distributed across a plurality of housings. Furthermore, at least part of the functions of the presentation system 3—such as part of the functions of the first arithmetic circuit 35—may be implemented by cloud computing or the like.

In a variation, the presentation system 3 and the information terminal 4 may be implemented as a single computer system. For example, a plurality of functions (components) of the presentation system 3 and the information terminal 4 may be integrated within a single housing.

### 3. Aspects

As apparent from the above embodiment and variations, the present disclosure includes the following aspects.

### [Aspect 1]

A presentation system comprising an arithmetic circuit accessible to energy information including information regarding a history of prices of a plurality of energy plans, environmental value information including information regarding a history of prices of a plurality of environmental value plans, and demand information including an energy demand and an environmental target,
the arithmetic circuit being configured to present, based on the energy information and the environmental value information, a plurality of combination plans of an energy plan and an environmental value plan which satisfy the energy demand and the environmental target, and an indicator value of a risk of price fluctuation for each of the plurality of combination plans.

### [Aspect 2]

The presentation system of aspect 1, wherein the arithmetic circuit is configured to present a first indicator value of a price and a second indicator value of a risk of price fluctuation for each of the plurality of combination plans.

### [Aspect 3]

The presentation system of aspect 2, wherein:
the first indicator value is an expected value; and
the second indicator value is a variance or a standard deviation.

### [Aspect 4]

The presentation system of aspect 3, wherein:
the demand information includes an allowable value for a risk of price fluctuation in a combination plan; and
the first indicator value and the second indicator value of each of the plurality of combination plans satisfy the allowable value.

### [Aspect 5]

The presentation system of any one of aspects 1 to 4, wherein:
the plurality of energy plans include a fixed price energy plan in which an energy price is constant and a variable price energy plan in which an energy price fluctuates;
the demand information includes energy selection information regarding whether to select the fixed price energy plan or the variable price energy plan;
the plurality of combination plans do not include one of the fixed price energy plan and the variable price energy plan which has not been selected by the energy selection information.

### [Aspect 6]

The presentation system of any one of aspects 1 to 5, wherein:
the plurality of environmental value plans include a fixed price environmental value plan in which an environmental value price is constant and a variable price environmental value plan in which an environmental value price fluctuates;
the demand information includes environmental value selection information regarding whether to select the fixed price environmental value plan or the variable price environmental value plan;
the plurality of combination plans do not include one of the fixed price environmental value plan and the variable price environmental value plan which has not been selected by the environmental value selection information.

### [Aspect 7]

The presentation system of any one of aspects 1 to 6, wherein:
the demand information includes designation information designating at least one of the plurality of energy plans and the plurality of environmental value plans; and
each of the plurality of combination plans includes at least one of the plurality of energy plans and the plurality of environmental value plans designated by the designation information.

### [Aspect 8]

The presentation system of any one of aspects 1 to 7, wherein:
the plurality of energy plans include a plurality of fixed energy plans in which an energy supply quantity is constant; and
at least one of the plurality of combination plans includes one of the plurality of fixed energy plans.

### [Aspect 9]

The presentation system of any one of aspects 1 to 7, wherein:
the plurality of energy plans include a plurality of fixed energy plans in which an energy supply quantity is constant and a plurality of variable energy plans in which an energy supply quantity fluctuates due to usage of renewable energy; and
at least one of the plurality of combination plans includes one of the plurality of fixed energy plans and one of the plurality of variable energy plans.

### [Aspect 10]

The presentation system of any one of aspects 1 to 7, wherein:
the plurality of energy plans include a plurality of variable energy plans in which an energy supply quantity fluctuates due to usage of renewable energy; and
at least one of the plurality of combination plans includes two or more of the plurality of variable energy plans.

### [Aspect 11]

The presentation system of aspect 10, wherein the two or more of the plurality of variable energy plans in which a third indicator value of a correlation between energy supply quantities is equal to or smaller than a threshold value.

### [Aspect 12]

The presentation system of aspect 11, wherein the third indicator value is a covariance of the energy supply quantities.

### [Aspect 13]

The presentation system of any one of aspects 1 to 7, wherein:
the plurality of energy plans include a plurality of fixed energy plans in which an energy supply quantity is constant but a price fluctuates; and
at least one of the plurality of combination plans includes two or more of the plurality of fixed energy plans.

### [Aspect 14]

The presentation system of aspect 13, wherein the two or more of the plurality of fixed energy plans in which a fourth indicator value of a correlation between energy prices is equal to or smaller than a threshold value.

### [Aspect 15]

The presentation system of aspect 14, wherein the fourth indicator value is a covariance of the energy prices.

### [Aspect 16]

The presentation system of any one of aspects 8 to 15, wherein the at least one of the plurality of combination plans does not include any of the plurality of environmental value plans or includes one of the plurality of environmental value plans.

### [Aspect 17]

The presentation system of any one of aspects 8 to 15, wherein:
the plurality of environmental value plans include a plurality of variable price environmental value plans in which a price fluctuates; and
the at least one of the plurality of combination plans includes two or more of the plurality of variable price environmental value plans.

### [Aspect 18]

The presentation system of aspect 17, wherein the two or more of the plurality of variable price environmental value plans in which a fifth indicator value of a correlation between environmental value prices is equal to or smaller than a threshold value.

### [Aspect 19]

The presentation system of aspect 18, wherein the fifth indicator value is a covariance of the environmental value prices.

### [Aspect 20]

The presentation system of any one of aspects 1 to 19, wherein the arithmetic circuit is configured to present an input screen to receive input of the energy demand.

### [Aspect 21]

The presentation system of any one of aspects 1 to 20, wherein the arithmetic circuit is accessible to consumption information regarding a history of an energy usage, and is configured to determine the energy demand based on the consumption information.

### [Aspect 22]

The presentation system of any one of aspects 1 to 21, wherein
the arithmetic circuit is configured to
when receiving selection information selecting one of the plurality of combination plans,
provide user information associated with the selection information to an energy provider and an environmental value provider respectively associated with an energy plan and an environmental value plan included in a combination plan selected by the selection information.

### [Aspect 23]

The presentation system of any one of aspects 1 to 22, wherein
the arithmetic circuit is configured to
when receiving modified demand information in which at least one of the energy demand or the environmental target is modified,
present, based on the energy information and the environmental value information, a plurality of modified combination plans of an energy plan and an environmental value plan which satisfy the energy demand and the environmental target included in the modified demand information, and an indicator value of a risk of price fluctuation for each of the plurality of modified combination plans.

### [Aspect 24]

A presentation method performed by an arithmetic circuit accessible to energy information including information regarding a history of prices of a plurality of energy plans, environmental value information including information regarding a history of prices of a plurality of environmental value plans, and demand information including an energy demand and an environmental target, comprising presenting, based on the energy information and the environmental value information, a plurality of combination plans of an energy plan and an environmental value plan which satisfy the energy demand and the environmental target, and an indicator value of a risk of price fluctuation for each of the plurality of combination plans.

### [Aspect 25]

A program for enabling the arithmetic circuit to perform the presentation method of aspect 24.

Aspects 2 to 23 are optional and not essential. Aspects 2 to 23 can be combined with aspect 24 appropriately.

### INDUSTRIAL APPLICABILITY

The present disclosure is applicable to presentation systems, presentation methods, and programs. More specifically, the present disclosure is applicable to a presentation system, a presentation method, and a program for selecting an energy plan and an environmental plan.

### REFERENCE SIGNS LIST

3 Presentation System
35 First Arithmetic Circuit (Arithmetic Circuit)
D1 Energy Information
D2 Environmental Value Information
D3 Demand Information

1. A presentation system comprising an arithmetic circuit accessible to energy information including information regarding a history of prices of a plurality of energy plans, environmental value information including information regarding a history of prices of a plurality of environmental value plans, and demand information including an energy demand and an environmental target,
the arithmetic circuit being configured to present, based on the energy information and the environmental value information, a plurality of combination plans of an energy plan and an environmental value plan which satisfy the energy demand and the environmental target, and an indicator value of a risk of price fluctuation for each of the plurality of combination plans.

2. The presentation system of claim 1, wherein the arithmetic circuit is configured to present a first indicator value of a price and a second indicator value of a risk of price fluctuation for each of the plurality of combination plans.

3. The presentation system of claim 2, wherein:
the first indicator value is an expected value; and
the second indicator value is a variance or a standard deviation.

4. The presentation system of claim 3, wherein:
the demand information includes an allowable value for a risk of price fluctuation in a combination plan; and
the first indicator value and the second indicator value of each of the plurality of combination plans satisfy the allowable value.

5. The presentation system of claim 1, wherein:
the plurality of energy plans include a fixed price energy plan in which an energy price is constant and a variable price energy plan in which an energy price fluctuates;
the demand information includes energy selection information regarding whether to select the fixed price energy plan or the variable price energy plan;
the plurality of combination plans do not include one of the fixed price energy plan and the variable price energy plan which has not been selected by the energy selection information.

6. The presentation system of claim 1, wherein:
the plurality of environmental value plans include a fixed price environmental value plan in which an environmental value price is constant and a variable price environmental value plan in which an environmental value price fluctuates;
the demand information includes environmental value selection information regarding whether to select the fixed price environmental value plan or the variable price environmental value plan;
the plurality of combination plans do not include one of the fixed price environmental value plan and the variable price environmental value plan which has not been selected by the environmental value selection information.

7. The presentation system of claim 1, wherein:
the demand information includes designation information designating at least one of the plurality of energy plans and the plurality of environmental value plans; and
each of the plurality of combination plans includes at least one of the plurality of energy plans and the plurality of environmental value plans designated by the designation information.

8. The presentation system of claim 1, wherein:
the plurality of energy plans include a plurality of fixed energy plans in which an energy supply quantity is constant; and
at least one of the plurality of combination plans includes one of the plurality of fixed energy plans.

9. The presentation system of claim 1, wherein:
the plurality of energy plans include a plurality of fixed energy plans in which an energy supply quantity is constant and a plurality of variable energy plans in which an energy supply quantity fluctuates due to usage of renewable energy; and
at least one of the plurality of combination plans includes one of the plurality of fixed energy plans and one of the plurality of variable energy plans.

10. The presentation system of claim 1, wherein:
the plurality of energy plans include a plurality of variable energy plans in which an energy supply quantity fluctuates due to usage of renewable energy; and
at least one of the plurality of combination plans includes two or more of the plurality of variable energy plans.

11. The presentation system of claim 10, wherein the two or more of the plurality of variable energy plans in which a third indicator value of a correlation between energy supply quantities is equal to or smaller than a threshold value.

12. The presentation system of claim 1, wherein:
the plurality of energy plans include a plurality of fixed energy plans in which an energy supply quantity is constant but a price fluctuates; and
at least one of the plurality of combination plans includes two or more of the plurality of fixed energy plans.

13. The presentation system of claim 8, wherein the at least one of the plurality of combination plans does not include any of the plurality of environmental value plans or includes one of the plurality of environmental value plans.

14. The presentation system of claim 8, wherein:
the plurality of environmental value plans include a plurality of variable price environmental value plans in which a price fluctuates; and
the at least one of the plurality of combination plans includes two or more of the plurality of variable price environmental value plans.

15. The presentation system of claim 1, wherein the arithmetic circuit is configured to present an input screen to receive input of the energy demand.

16. The presentation system of claim 1, wherein the arithmetic circuit is accessible to consumption information regarding a history of an energy usage, and is configured to determine the energy demand based on the consumption information.

17. The presentation system of claim 1, wherein
the arithmetic circuit is configured to
when receiving selection information selecting one of the plurality of combination plans,
provide user information associated with the selection information to an energy provider and an environmental value provider respectively associated with an energy plan and an environmental value plan included in a combination plan selected by the selection information.

18. The presentation system of claim 1, wherein
the arithmetic circuit is configured to
when receiving modified demand information in which at least one of the energy demand or the environmental target is modified,
present, based on the energy information and the environmental value information, a plurality of modified combination plans of an energy plan and an environmental value plan which satisfy the energy demand and the environmental target included in the modified demand information, and an indicator value of a risk of price fluctuation for each of the plurality of modified combination plans.

19. A presentation method performed by an arithmetic circuit accessible to energy information including information regarding a history of prices of a plurality of energy plans, environmental value information including information regarding a history of prices of a plurality of environmental value plans, and demand information including an energy demand and an environmental target, comprising presenting, based on the energy information and the environmental value information, a plurality of combination plans of an energy plan and an environmental value plan which satisfy the energy demand and the environmental target, and an indicator value of a risk of price fluctuation for each of the plurality of combination plans.

20. A non-transitory storage media storing a program for enabling the arithmetic circuit to perform the presentation method of claim 19.
